(19) United States
(12) Patent Application Publication
(10) Pub. No.: US 2026/0277072 A1
(43) Pub. Date: Sep. 17, 2026

(54) Integrated Frequency Modulated Optical Parametric Oscillator Frequency Combs and Optical Spectroscopy using same

(71) Applicant: The Board of Trustees of the Leland Stanford Junior University, Stanford, CA (US)

(72) Inventors: Amir H. Safavi-Naeini, Stanford, CA (US); Hubert S. Stokowski, Palo Alto, CA (US); Alexander Yi-Kai Hwang, Palo Alto, CA (US)

(21) Appl. No.: 19/469,109

(22) PCT Filed: Apr. 12, 2024
(86) PCT No.: PCT/US2024/024444

§ 371 Date: Sep. 25, 2025

Related U.S. Application Data
(60) Provisional application No. 63/458,784, filed on Apr. 12, 2023.

(51) Int. Cl. G02F 1/39; G01J 3/10; G01J 3/26; G02F 1/355

(52) U.S. Cl. CPC G02F 1/395; G01J 3/10; G01J 3/26; G02F 1/3558; G02F 2202/20; G02F 2203/56

(57) ABSTRACT

Improved optical comb generation from an integrated photonic device is obtained by intracavity optical modulation of a photonic integrated circuit optical parametric oscillator. The resulting device is referred to an FM-OPO. The comb spectrum from an FM-OPO is much broader than obtained from conventional integrated comb generators relying on the electro-optic or Kerr effects. There is also no mode-locking or pulse formation in an FM-OPO. Mid-IR spectroscopy is one of the most promising applications of FM-OPOs.

### FIELD OF THE INVENTION

This invention relates to generation of optical frequency combs.

### BACKGROUND

Optical frequency combs, characterized by their precisely spaced, sharp spectral lines that serve as a ‘frequency ruler’ for light, are indispensable tools in numerous fields, from precision metrology and atomic clocks to high-capacity telecommunications and molecular spectroscopy. Fueled by their potential practical applications, the drive to miniaturize frequency combs into chip-scale integrated devices, known as microcombs, has recently accelerated at a remarkable pace. Conventional optical frequency combs, produced through mode-locked lasers and synchronously pumped optical parametric oscillators (OPOs) are large and require substantial infrastructure, such as complex feedback systems or high-power lasers. As a result, their cost is high, and their use outside laboratory settings is limited. Two principal methods for creating integrated frequency comb sources suitable for smaller, deployable devices have been explored in response. The first involves third-order χ⁽³⁾ or Kerr optical nonlinearity, with successful demonstrations in materials such as silica, silicon nitride, aluminum nitride, silicon carbide and lithium niobate (LN). The second strategy uses the electro-optic (EO) effect, which has been realized in resonant (FIG. 1A) and non-resonant integrated thin-film LN devices. Despite these remarkable advances, EO and Kerr combs face several challenges. These combs are often limited in their efficiency, exhibit a strong pump background, suffer from limited tunability and display an exponentially decreasing comb line intensity for the lines distant from the pump. Moreover, Kerr frequency combs demand sophisticated control and become substantially more challenging to operate at a smaller free spectral range.

Accordingly, it would be an advance in the art to provide improved optical frequency combs from integrated photonic circuits.

### SUMMARY

This work enables scalable and integrated light sources with applications in optical spectroscopy. The light source is either a singly- or doubly-resonant frequency modulated optical parametric oscillator (FM-OPO) realized in a photonic integrated circuit. An exemplary device is based on, but not limited to, an optical racetrack, or microring resonator, formed from a tightly-confining waveguide fabricated in a material with strong second-order nonlinearity that enables a three-wave mixing process, such as but not limited to, lithium niobate. The FM-OPO can be operated in a frequency-modulated mode to produce an optical frequency comb.

Light is generated in an FM-OPO through a second-order nonlinear process by dividing the energy of pump photons into two, referred to as signal and idler. The FM-OPO can simultaneously generate a comb of optical frequencies by frequency modulation. This modulation is realized through the electro-optic effect in a tightly confining waveguide fabricated in a material such as but not limited to lithium niobate, which is modulated by an RF field applied through electrodes patterned near the resonator waveguide. The electro-optic effect can be realized at any wavelength within the transparency window of the crystal. The output wavelength of the generated light is controlled by tuning the pump wavelength, temperature, or DC voltage applied to the intracavity phase modulator.

Increasing the accessible output bandwidth is possible through dispersion engineering (i.e., changing the geometry of the nanophotonic waveguide or cladding material). The operating wavelength range of the FM-OPO can be engineered freely by the design of the periodic poling and is mainly limited by the transparency range of utilized materials. The waveguide materials include but are not limited to lithium niobate, potassium titanyl phosphate (KTP), and lithium tantalate. In some embodiments, signal, and idler are resonant, which is referred to as a doubly-resonant FM-OPO. In some embodiments, the signal is resonant, and the idler is non-resonant, which is referred to as a singly-resonant FM-OPO.

FM-OPOs are suitable for optical spectroscopy sources that can be utilized to detect specimens such as but not limited to: gases, liquids, biological samples, drugs, and explosives. In addition, the broad range of accessible wavelengths enables applications in areas such as, but not limited to: environmental monitoring (greenhouse gases, industrial contamination, chemical spills, and likewise), defense (detection of illegal substances, explosives), medical (biomarkers), industry (process control), food production, and agriculture.

Integrated FM-OPO embodiments can be based on a racetrack resonator, with one section periodically poled to provide momentum matching for the three-wave mixing interaction, and another waveguide section coupled to the RF field through metal electrodes patterned nearby. The resonator includes a waveguide coupler (directional coupler or adiabatic coupler) designed to selectively transmit light at signal or signal and idler wavelengths without transmitting pump light strongly. The pump frequency is not resonating.

In contrast to the prior art, especially commercially-available systems based on bulk crystals, the nanophotonic FM-OPO embodiments with specially designed waveguide geometries enable: 1) Significantly reduced footprint that enables integration within deployable sensors; 2) Reduced power consumption; 3) Viable integration with complex photonic integrated circuits; 4) Dispersion engineering to reach wavelength bandwidths not possible in bulk systems. Furthermore, in comparison with other microcomb sources such as Kerr- and pure EO-combs, the nanophotonic FM-OPO enables: 1) Spectrally flat frequency comb; 2) Removal of pump laser background that is typically orders of magnitude more substantial than the comb line intensities; 3) Lower free-spectral range, especially compared to Kerr combs; 4) Two combs can be generated with a very small difference in the free spectral range, which increases the resolution of dual-comb spectroscopy and allows using photodetectors with smaller electrical bandwidth.

In some embodiments, specifically, those employing z-cut lithium niobate, microring resonators are used instead of a racetrack. The z-cut lithium niobate embodiment uses fundamental TM modes of a waveguide and allows for periodic poling of the entire resonator length, including bends. In this embodiment, metal electrodes are patterned in such a way as to generate an electric field normal to the lithium niobate plane.

In some embodiments, the pump light is generated on the same nanophotonic chip through second harmonic generation from a pump at half of its frequency. In some embodiments, individual OPOs and/or FM-OPOs are integrated into larger photonic integrated circuits, including, but not limited to, waveguide couplers, filters, electro-optic and thermo-optic modulators, heterogeneously integrated lasers and detectors, and diffraction elements.

An exemplary embodiment is a parametric light source comprising: a substrate; tightly confining optical waveguides made out of a material with second-order nonlinearity (such as lithium niobate) bonded on top of the substrate; optical resonator formed out of the waveguides; periodically-poled waveguide supporting nonlinear light generation; waveguide coupler within the optical cavity; metal electrode patterned in the close vicinity of the cavity waveguide and coupled to an external RF source.

### BRIEF DESCRIPTION OF THE DRAWINGS

FIGS. 1A-B show operating concepts of EO comb generation and FM-OPO comb generation.

FIG. 2A is a schematic diagram showing the FM-OPO device configuration for our experiments.

FIG. 2B is a microscope image of the device of FIG. 2A.

FIG. 2C shows the output spectrum of the device of FIG. 2A compared to an output spectrum from an EO comb generator.

FIGS. 3A-B show tuning characterization of the FM-OPO when modulated and not modulated.

FIGS. 4A-D shows further characterization results for the FM-OPO.

FIG. 5A-C show energy level diagrams relating to operation of the FM-OPO.

FIG. 6 shows an alternative FM-OPO device configuration.

FIGS. 7A-B show two alternatives for couplers.

FIGS. 8A-C show several electrode configurations, depending on whether the material is x-cut or z-cut.

FIG. 9 is a block diagram relating to spectroscopy with an FM-OPO source.

FIGS. 10A-C show several FM-OPO configurations suitable for use in spectroscopy applications.

FIGS. 11A-C show proof of concept results for mid-IR spectroscopy using FM-OPO sources.

### DETAILED DESCRIPTION

### I) Introduction

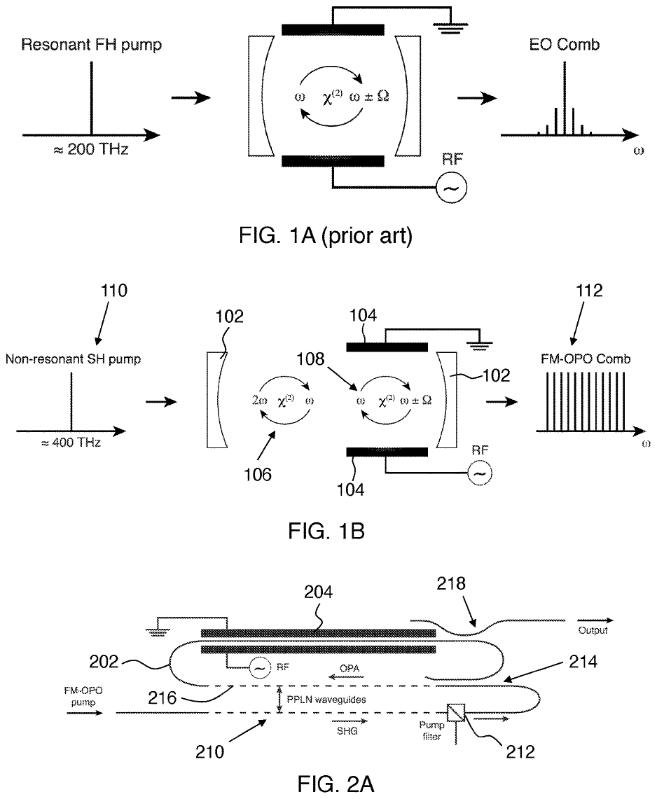

FIGS. 1A-B show Frequency combs in an EO resonator and in the FM-OPO. In a standard EO comb (FIG. 1A), an optical resonator conducts EO modulation on a single laser pump. This results in an output of equally spaced lines with intensities that decay exponentially. The FM-OPO (FIG. 1B) uses the second harmonic (SH) as a pump and emits light at the fundamental frequency. An EO modulator couples the neighboring cavity modes, creating an evenly distributed output comb. Here the optical resonator is schematically shows as mirrors 102, electrodes 104 provide the electrical input for EO modulation, 106 schematically shows the optical parametric amplification, 108 schematically shows the EO modulation, 110 shows the input pump, and 112 shows the output frequency comb.

In this concept, we consider and demonstrate a previously unknown type of microcomb that combines the advantages of both EO and Kerr combs, merging nonlinear optical processes with EO modulation in an integrated device. Specifically, our structure accommodates both optical parametric amplification and phase modulation within a single cavity, thereby facilitating the generation of a frequency-modulated optical parametric oscillator (FM-OPO; FIG. 1B). Remarkably, unlike in conventional Kerr and EO combs, the dynamics in our system do not result in pulse formation, making the output more closely resemble that of a frequency-modulated laser. In contrast to a serrodyne approach, the radio-frequency (RF) modulation we use has only a single Fourier component. This strategy maintains the operational simplicity characteristic of EO combs while achieving substantially broader bandwidths than those attainable through modulation alone. Furthermore, our technique gives rise to a flat-top output comb with most lines within 3 dB of the mean, an optimal spectral distribution for many applications, while avoiding unwanted nonlinearities that manifest at large pulse peak powers. Finally, the FM-OPO exhibits impressive efficiency, converting a substantial fraction of the pump light into comb lines while demanding only modest RF power inputs for operation.

To demonstrate the integrated FM-OPO, we turn to thin-film LN for its strong second-order optical nonlinearity and EO effect. Thin-film LN has recently emerged as a platform for integrated nanophotonics through demonstrations of efficient EO modulators, EO combs, periodically poled LN waveguides for frequency conversion, quantum light generation, resonant second-harmonic generation and OPOs, and integration with complex photonic integrated circuits for applications such as laser control and quantum measurements. The above demonstrations are either based on the EO effect that transfers energy between optical modes separated by the RF frequency or the χ⁽²⁾ nonlinearity that can provide broadband gain. Combining these two distinct capabilities forms the foundation for the integrated FM-OPO. Moreover, our choice of LN is motivated by its strong potential for large-scale manufacturability as evidenced by efforts now pursued in industry

### II) Comb Dynamics

Both Kerr and EO comb generation fundamentally rely on mode locking, which subsequently leads to the formation of pulses. However, this process inherently introduces a strong frequency-dependent variation in the intensity of the comb lines that decay exponentially with their offset from the center. Another considerable challenge posed by pulse formation is the inefficient use of pump power, as a continuous-wave pump overlaps only with a small part of the circulating field. Recent advancements have started to address this issue, mainly by exploiting auxiliary resonances and using pulsed pumps. Finally, pulse formation leads to large intracavity peak powers that can engage other unwanted nonlinearities and make comb formation challenging in integrated platforms. We discover here that incorporating parametric gain into an EO-modulated cavity leads to a frequency comb without necessitating pulse formation. Our device demonstrates high efficiency, reduced pump background, and spectral flatness. In contrast to the extensive engineering and operation dynamics required for similar results by the Kerr combs, the FM-OPO offers an alternative versatile solution. Moreover, unlike pure EO combs, the FM-OPO requires only modest RF power, enabling scalability and applications in deployable sensors. Despite the modulation being close to the cavity resonance mode spacing, the dynamics of our system strikingly resemble those of a frequency-modulated laser. As in a frequency-modulated laser, we will see that the optical frequency of the signal is swept across a bandwidth BW at the rate of the RF modulation Q.

We first consider the situation without any modulation. We assume that we operate the OPO non-degenerately so that it emits signal and idler tones at mode number offsets ±n_{osc} from a central mode with frequency ω₀ close to half of the pump frequency ωₚ/2. As we introduce RF modulation at frequency Ω characterized by a mode-coupling rate M, these signal and idler tones are simultaneously subject to gain and modulation. The pairing of these effects around the signal and idler creates conditions that mirror the dynamics of a frequency-modulated laser, in which phase-insensitive gain and modulation coexist.

In a frequency-modulated laser, the limiting behavior that prevents mode locking arises from a detuning between the FSR of the cavity and the drive frequency Ω. The frequency-modulated laser then transitions to chaotic and mode-locked states as this detuning is reduced and the bandwidth is increased to approach the gain bandwidth of the medium or a limit set by the cavity dispersion. The oscillation bandwidth of the FM-OPO is limited by the dispersion of the cavity, characterized by mode frequencies ωₙ=ω₀+ζ₁n+ζ₂n²/2, where ζ₁ and ζ₂ are the cavity FSR near ω₀ and the second-order dispersion, respectively. Under the regime considered, our device avoids the transition to mode-locking behavior. The signal and idler modes are far separated and experience local FSRs near ±n_{osc} that differ from each other by 2n_{osc}ζ₂. Moreover, the parametric nature of the process necessitates the simultaneous formation of combs at both signal and idler frequencies. Therefore, in the assumed non-degenerate regime, there is always effectively a drive detuning when we consider both signal and idler combs. This results in dynamics that closely mirror those of a frequency-modulated laser with detuned driving, in which continuous frequency sweeping is observed rather than pulse formation. The effective bandwidth is given by

$$BW ≡ 2 ΓΩ = \frac{4 M Ω}{{n}_{osc} {ζ}_{2}} \qquad ( 1 )$$

where Γ is the modulation index, and the signal and idler tones are frequency modulated as a_{s,i}(t)≈A_{s,i}e^{-ω}^{ᵢ}^{t}e^{±iΓ sin(Ωt)}e^{iω}^{ₚ}^{t/2}. The bandwidth formula aligns well with the established expression for the frequency-modulated laser bandwidth BW∝MΩ/(Ω−FSR), with the correspondence being that the frequency-modulated laser detuning Ω−FSR is replaced by the detuning n_{osc}ζ₂ between the drive and local FSR in the FM-OPO. Finally, we note that there are conditions for which the above analysis no longer holds, for example, at (near-) degenerate OPO operation leading to smaller n_{osc}, at substantially larger M or for dispersion-engineered waveguides that may match the local signal or idler FSRs. Bulk phase-modulated OPOs have already been demonstrated. In contrast to the FM laser, the FM bandwidth and the gain bandwidth of the FM-OPO are both defined through dispersion engineering.

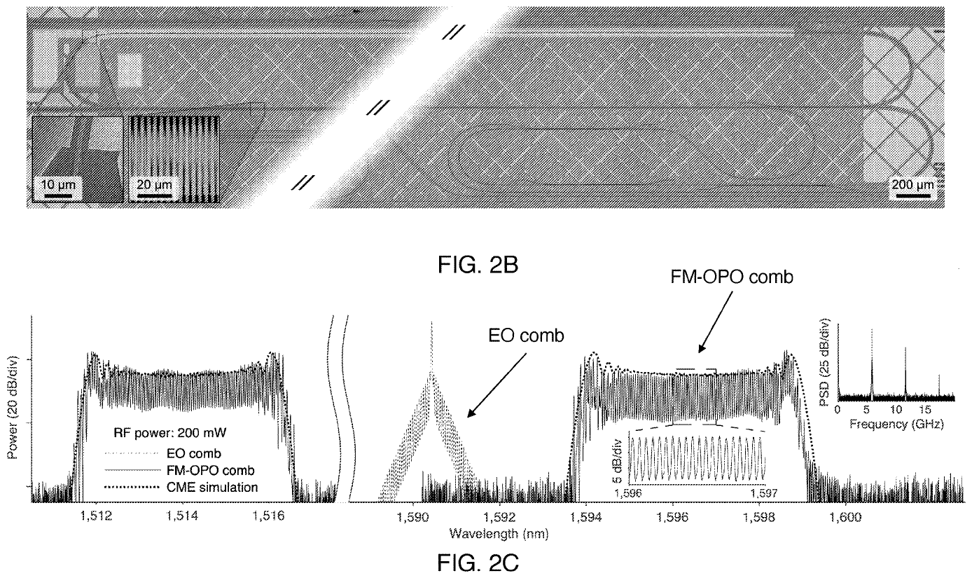

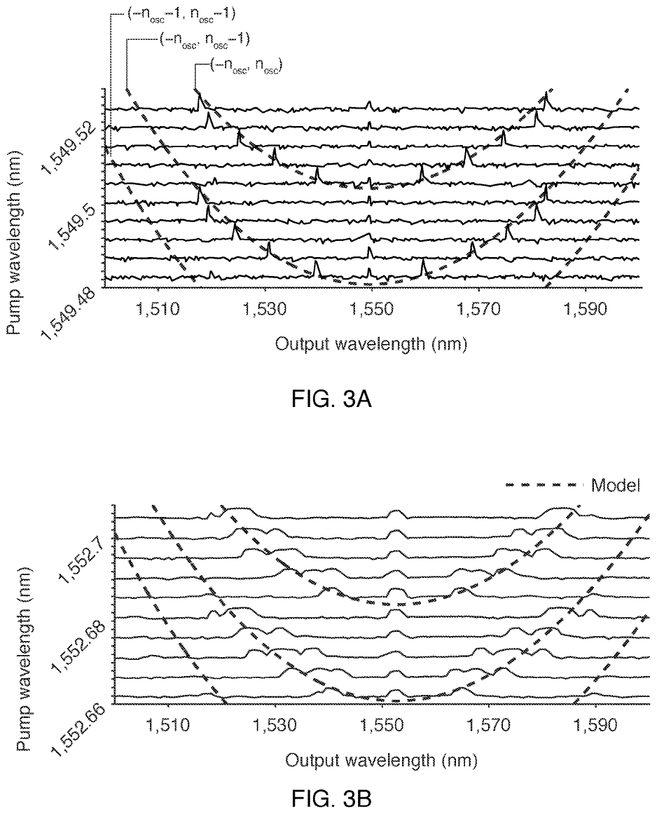

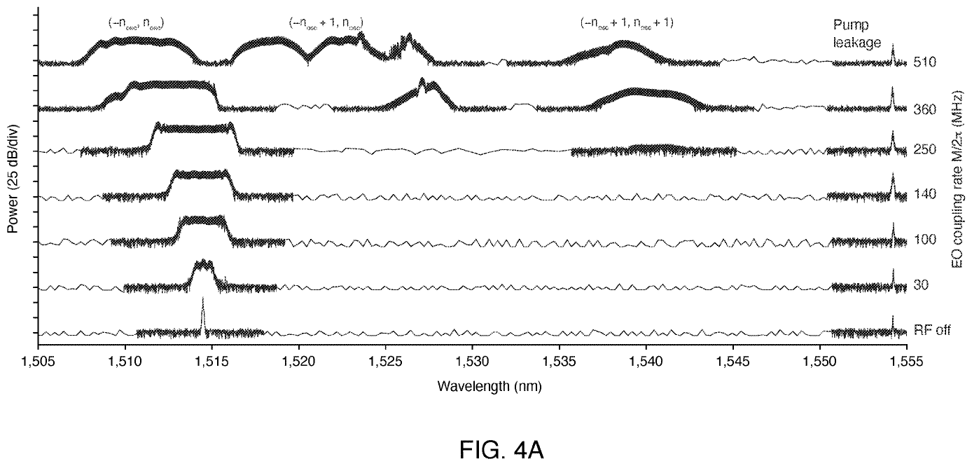

FIGS. 2A-C show some aspects of the FM OPO device. As shown on FIG. 2A, the device features a racetrack resonator 202 with an intracavity waveguide coupler 214, which allows only the fundamental harmonic to resonate while enabling the second harmonic to traverse the device once. The straight section of one racetrack contains a periodically poled waveguide 216 for second-order optical nonlinearity, whereas the other straight racetrack section couples to microwaves through on-chip electrodes 204. A single-pass waveguide doubler 210 (also periodically poled) on the same chip generates the pump of the OPO at the second-harmonic frequency, which is separated from the input C-band laser light using a series of filters 212. An output coupler 218 provides the output of the device.

The microscope image of FIG. 2B shows the FM-OPO racetrack resonator, with the center removed for clarity. The dark lines represent integrated waveguides. The structure atop the racetrack is a gold microelectrode slot waveguide that links with microwaves. The SEM micrograph in the left inset depicts the waveguide between the electrodes. The bottom of the racetrack is periodically poled, as shown in the second-harmonic microscope image of the poled film in the second inset. The waveguide circuit in the bottom-right corner is a pump-filtering section after the second-harmonic generation (SHG) waveguide. Scale bars, 200 μm (FIG. 2B, main image); 10 μm (FIG. 2B, left inset); and 20 μm (FIG. 2B, right inset).

FIG. 2C shows the output spectrum of the FM-OPO produces approximately 200 unique oscillator modes at the signal and idler frequencies using about 140 mW of input optical power and 200 mW of RF power. The dotted line represents a coupled-mode theory simulation result. The bottom-right inset magnifies into the flat area of the comb, whereas the top-right inset shows an RF power spectral density (PSD) of the FM-OPO output, detected using a fast photodiode with peaks at multiples of the cavity FSR. CME, coupled-mode equation; OPA, optical parametric amplification; PPLN, periodically poled LN.

We demonstrate an optical frequency comb generator based on an FM-OPO integrated on a chip. The device evenly distributes 11 mW of optical power over 200 comb lines using 140 mW of C-band optical pump power and 200 mW of RF modulation power. Comb lines are spaced by about 5.8 GHZ. We base our device on a racetrack resonator in thin-film LN on an insulator with intrinsic quality factors of around Qᵢ≈10⁶. This resonator holds within it an EO modulator, an optical parametric amplifier and a high-efficiency wavelength-selective coupler that nearly fully transmits the 780 nm pump while keeping the C-band excitation within the cavity. FIG. 2A shows a schematic of the device, whereas FIG. 2B shows a microscope image of a single FM-OPO device. The coupler enables our device to operate as a doubly resonant OPO in which the pump passes through the optical parametric amplifier but is non-resonant in the cavity. One straight section has gold electrodes patterned next to it, enabling EO modulation of the cavity (FIG. 2B, left inset). The other straight section of the cavity is a periodically poled LN waveguide that provides parametric gain when pumped with the second harmonic (see FIG. 2B, right inset, for a second-harmonic microscope picture of the poled thin-film LN).

We generate the 780-nm pump on the same chip in a separate periodically poled LN waveguide by second-harmonic generation. We filter out the original pump field through three on-chip filters of the same design as the intracavity coupler. The high second-harmonic generation efficiency enables us to achieve considerable optical pump powers using only a standard commercial C-band laser. FIG. 2C shows an example FM-OPO output spectrum when the device is pumped with around 140 mW of fundamental-harmonic optical power (corresponding to around 100 mW of second-harmonic power) and 200 mW of RF power, equivalent to about 4.5 V peak voltage. On FIG. 1C, we also plot an EO comb generated using the same RF power within the same cavity for comparison. We observe a flat comb formation around signal and idler wavelengths and no substantial background from the pump. The measured output aligns with our coupled-mode theory model (dotted line) described below. The bottom-right inset in FIG. 2C shows individual lines in a flat spectrum spaced by around 5.8 GHZ. The observed contrast of around 15 dBm between maxima and minima results from the limited resolution of the optical spectrum analyzer rather than the nature of the FM-OPO. The top-right inset in FIG. 2C shows the result of collecting the output using a fast photodetector and an RF spectrum analyzer. In the RF spectrum, we observe narrow lines spaced by the multiples of the cavity FSR, resulting from the FM-OPO sweeping over a frequency-dependent output coupler.

We can understand nearly all the salient features of the observed spectra in the context of an approximate time-domain coupled-mode theory analysis. We also use this formulation to derive the formula for the comb bandwidth shown in equation (1), which agrees well with observations. We define mode amplitudes an to represent the field amplitudes for the nth mode around the fundamental-harmonic frequency, where n=0 corresponds to the fundamental mode closest to half of the pump frequency. In this context, b represents the amplitude of the second-harmonic pump field. Each mode n has a natural frequency given by the cavity dispersion with ζ₁/2π≈5.8 GHZ and ζ₂/2π≈−11 KHz corresponding to the cavity FSR and the second-order dispersion, respectively. Other key parameters include the laser drive detuning Δ=ωₚ/2−ω₀, and the RF drive detuning from the FSR δ=Ω−ζ₁. The mode coupling due to modulation M, which is proportional to the RF drive voltage, and the nonlinear coupling rate g provide the critical ingredients for realizing the comb dynamics. We also include the loss rates of the considered field amplitudes, κ_{a,n} and κ_{b}. The rate κ_{b} corresponds to that of an extremely lossy single-pass ‘cavity’ and enables us to approximate our DRO in this coupled-mode theory formulation. We derive all of the model parameters from independent simulations, as well as experimental and theoretical analysis. The resulting coupled-mode equations are

$${\dot{a}}_{n} = [ i ( Δ + n δ - \frac{{n}^{2} {ζ}_{2}}{2} ) - \frac{{κ}_{a , n}}{2} ] {a}_{n} - iM ( {a}_{n - 1} + {a}_{n + 1} ) - {i2ga}_{- n}^{*} b \qquad ( 2 )$$

$$\dot{b} = - \frac{{κ}_{b}}{2} b - ig {\sum }_{n} {a}_{n} {a}_{- n} + i \sqrt{{κ}_{b}} {β}_{in} \qquad ( 3 )$$

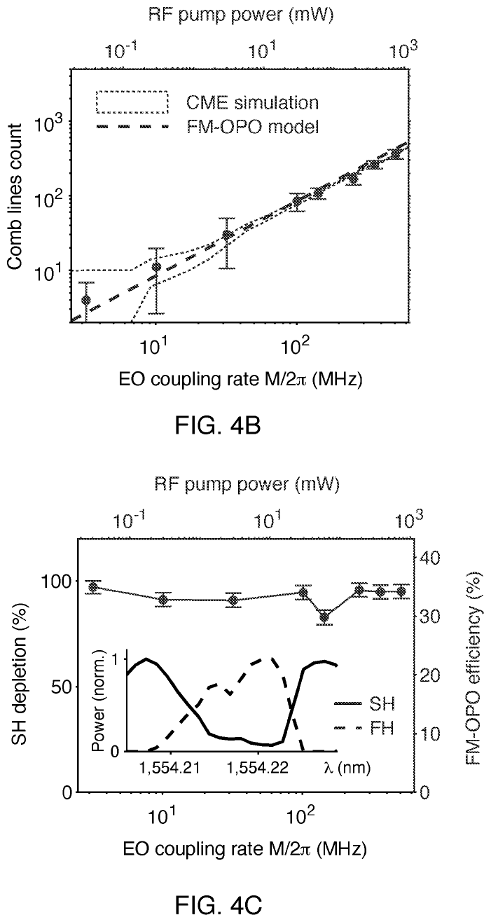

There are two main approximations in these equations. First, because we represent the pump field as the excitation of a very lossy mode b, solutions involving substantial spatial variations of the pump field along the waveguide cannot be represented accurately by this model. Second, we include only coupling between modes n and −n− we ignore the weaker coupling between modes with nearby n numbers. For example, coupling between n and −n+1 can be present and may become stronger as a function of pump wavelength. Tuning the pump wavelength and consequently the detuning Δ over a cavity FSR changes the mode pairs that are amplified (FIG. 3A).

FIGS. 3A-B show the effect of pump-wavelength tuning of the FM-OPO. For comparison, FIG. 3A shows pump-wavelength tuning of the devices operated as an unmodulated doubly resonant OPO (DRO). The solid traces relate to optical spectrum analyzer measurements. The output wavelength of the DRO is determined by the frequency matching between the signal and idler modes with respect to the pump. The thick dashed lines, recurring every 1/2 free spectral range, correspond to the theoretical model. FIG. 3B shows that the pump-wavelength tuning of the FM-OPO aligns with the pure OPO trend. However, the entire frequency-modulated clusters of modes tune synchronously along the energy-conservation lines. For both FIGS. 3A and 3B, one division on the y axis corresponds to a 50-dB change in the detected optical power for each optical spectrum analyzer trace.

We tune the output wavelength in the FM-OPO through small adjustments to the pump wavelength, enabling the output to span the full range of the gain spectrum. This tuning is predominantly influenced by the cavity dispersion, mirroring the characteristics observed in an unmodulated OPO. We show the OPO tuning behavior in FIG. 3A. The solid lines correspond to measurements with an optical spectrum analyzer, whereas the thick dashed lines present the predicted tuning behavior based on the waveguide dispersion. The FM-OPO exhibits a similar tuning pattern, as shown in FIG. 3B. Here, the comb clusters closely follow the expected tuning. By adjusting the pump wavelength by 23 μm (or 2.9 GHZ), which equates to half of the FSR of the cavity, we can access bandwidth of approximately 70 nm (or 8.7 THz) for both FM-OPO and OPO.

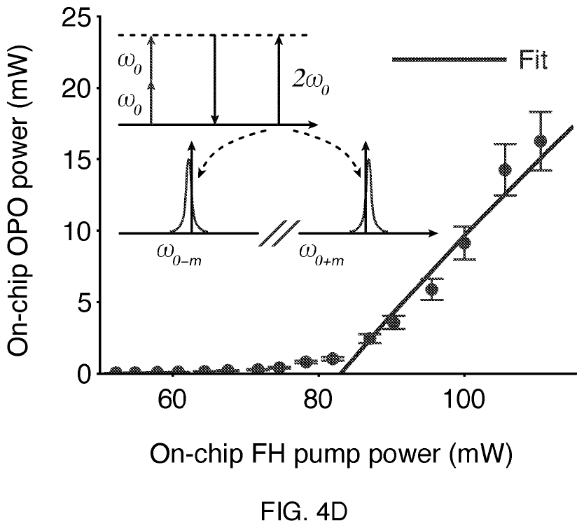

FIGS. 4A-D show power tunability of the FM-OPO. FIG. 4A shows evolution of combs with the EO drive. As the EO coupling increases, we observe comb growth and the emergence of secondary combs that couple (−n_{osc}+m, nosc) modes, aligning with several dashed lines in FIG. 3B. We combine high-resolution (approximately 20 μm) measurements from areas with detectable signals and low-resolution readings from the rest of the range. We primarily focus on the signal around 1, 515 nm for simplicity. The peak around 1, 554 nm is because of a minor leakage of the initial pump into the cavity. FIG. 4B shows the maximum count of individual oscillating lines in the FM-OPO as a function of EO coupling. The dotted line region corresponds to the prediction from the coupled-mode theory. We plot the comb count predicted with the FM-OPO theory with a thick dashed line. On FIG. 4C, we measure the depletion of the FM-OPO optical pump of around 93%, corresponding to the conversion efficiency of around 34%. The inset shows the normalized second-harmonic generation pump (solid line) and FM-OPO (dashed line) when changing the pump wavelength at M/2π≈30 MHz. The contrast between the second-harmonic maximum and minimum defines depletion. FIG. 4D shows the output power of the pure OPO as a function of the pump power at the fundamental-harmonic frequency. The pump initially generates a second harmonic in a single-pass waveguide that later drives the OPO. A line fitting to the data shows a nonlinear coupling rate g/2π of approximately 12 kHz.

We measure the spectra generated by the FM-OPO using an optical spectrum analyzer. We find that the device operates continuously and robustly in a non-degenerate mode at around n_{osc}≈800. In this regime, we expect equation (1) to hold to high accuracy. We pump the device at 1, 554 nm with about 140 mW. We step the EO coupling rate of the 5.8-GHz EO modulation between 0 MHz and around 510 MHz by varying the RF power supplied to the chip. As shown in FIG. 4A, we observe a frequency comb develop. Several additional comb clusters labelled (−n_{osc}+1, n_{osc}) and (−n_{osc}+1, n_{osc}+1) appear at a drive exceeding M/2π≈360 MHz. Although the single-cluster comb states that are generated for M below 250 MHz are easier to understand and model, and will likely be more useful in a practical system, we also present the states that arise at larger values of M, and that result in multiple FM-OPO clusters. These are predicted by our theoretical analysis. We plot only the signal combs (blue detuned) and omit the idler combs (red detuned) for clarity. The measured spectral peak at around 1,554 nm corresponds to a slight leakage of the original fundamental-harmonic pump into the cavity. We count the number of generated lines within the 3 dB bandwidth of the mean comb power and plot this in FIG. 4B. We observe good agreement between the data, numerical solution of the coupled-mode equations (2) and (3) (thin dashed lines) and the analytical expression for the FM-OPO given by equation (1) (thick dashed line). At the highest EO modulation rate of around 1.2 W, we observe more than 1,000 comb lines oscillating together within −30 dB from the flat-top mean power.

The FM-OPO operates with high efficiency, converting around 34% of the input second-harmonic light into comb lines. First, the intracavity conversion efficiency is high, exceeding 90%, based on the pump depletion measurement in FIG. 4C. We chose to use depletion because it is self-calibrating and enables us to calculate the efficiency based on the contrast between the measured maxima and minima of the normalized second-harmonic power, visible when tuning the pump wavelength, as shown in the inset. Next, the intracavity comb is out-coupled with the cavity escape efficiency ηₐ≈0.36, which limits the total efficiency of our device. Note that the depletion and the conversion efficiency do not depend on the RF drive strength. However, the efficiency depends on the optical pump power and is maximized at around four times the threshold. The output power of the FM-OPO resembles a typical behavior of an unmodulated OPO in FIG. 4D, in which we observe a threshold of about 47 mW second-harmonic power and nonlinear coupling rate g/2π≈12 kHz, lower than the predicted 67 kHz, which we attribute to operating at non-perfect phase matching Δk≠0. The low power requirements of our device enable direct integration with chip-based lasers to build self-contained comb generators.

### III) Discussion

We have successfully demonstrated a new type of integrated comb generator and established its fundamental operating principles. Our device demonstrates exceptional brightness, flatness and efficiency while retaining robust operational dynamics. Increasing the bandwidth and using the nonlinearities of LN will enable f-2f locking, leading to a truly coherent frequency comb in the stricter sense. Group velocity matching signal and idler will enable engineering parametric gain bandwidth to cover as much as 3-4 μm, expanding the use of the FM-OPO in mid-infrared spectroscopy. Given that our initial demonstration still has the potential for marked improvements in optical bandwidth by dispersion engineering, RF power consumption by resonant enhancement and optical conversion efficiency by improved out-coupling, this breakthrough opens the door to a new class of deployable optical frequency combs. For the application of these combs to the problems of spectroscopy, the versatility of the LN material platform allows for spectral coverage from blue light into the mid-infrared, enabling their use in fields such as medical diagnostics, process control in agriculture, food production and various industrial sectors. Although the comb teeth spacing of our current devices is around 5.8 GHz, our platform can achieve an FSR of 50 GHz to meet telecom standards and even exceed 100 GHz, given established modulators. Therefore, we anticipate flat-top combs generated with FM-OPOs to find applications as sources in fiber communication systems. Moreover, they are invaluable for ranging applications using FMCW (frequency-modulated continuous wave) LiDAR (light detection and ranging).

### IV) Supplemental Information

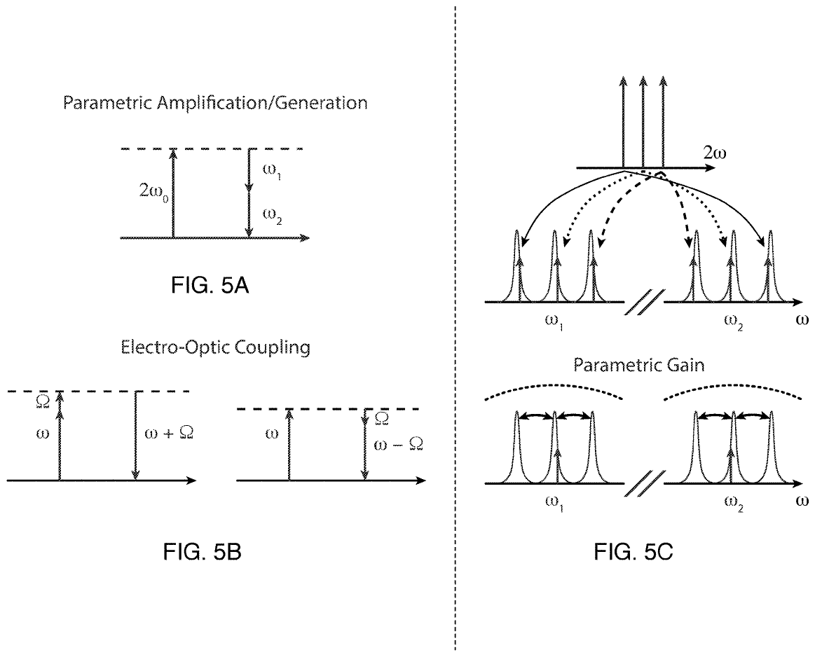

FIGS. 5A-C show some aspects of the relevant physics in more detail. FIG. 5A shows relevant energies for parametric amplification. Here a pump photon at 200 splits into two photons at ω₁ and ω₂. Energy conservation requires 2ψ₀=ω₁+ω₂). FIG. 5 B shows relevant energies for electro-optical coupling. Here modulation of light at frequency ω by an RF frequency Ω leads to emission at frequencies ω+Ω and ω−Ω. FIG. 5C shows the effect of OPO pump tuning on the output frequency of the oscillation. Electro-optic coupling at frequency Ω couples the amplitudes of photons at frequencies ω±Ω, that get amplified withing the range of the parametric amplifier (lower part of figure).

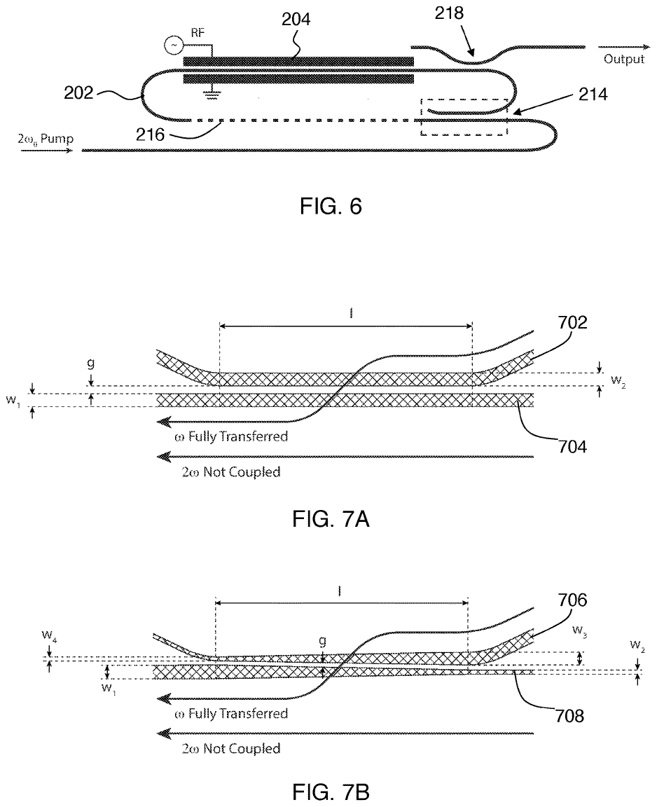

FIG. 6 shows an alternative and simpler photonic circuit implementation of the FM-OPO. It differs from the example of FIG. 2A by omitting the on-chip frequency doubler. Thus the pump here needs to be at 2ω₀, as indicated.

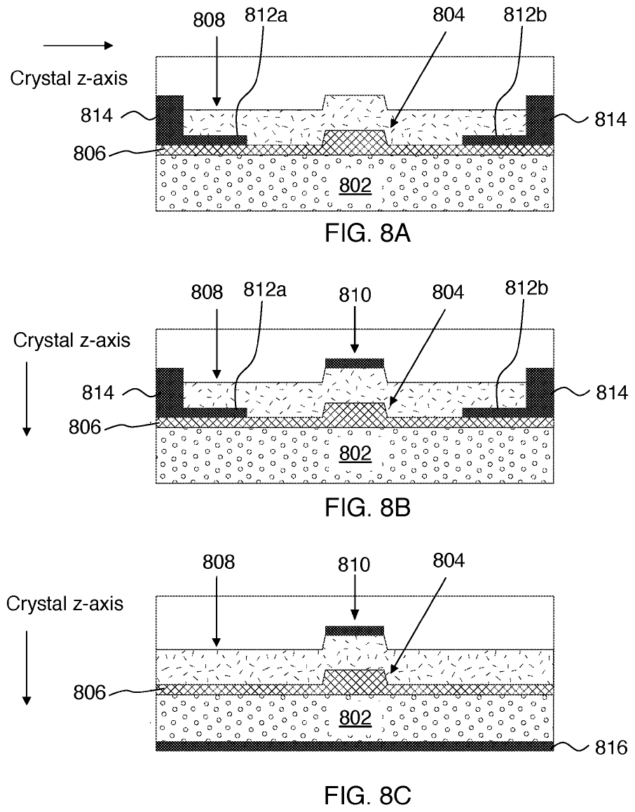

The FM-OPO cavity design involves an intracavity coupler designed to transfer all the light at the signal or signal and idler frequencies. This coupler can be a directional coupler with two waveguides (702 and 704) evanescently coupled to each other. FIG. 7A depicts such a structure, where w₁=w₂, the length l is designed to transfer all the light at the desired frequency ω, and the gap g is large enough to avoid coupling of the 2ω light.

In some embodiments, the intracavity coupler is an adiabatic coupler, as depicted in FIG. 7B. This design includes two waveguides, 706 and 708, each with a slowly varying width. On the right side of FIG. 7B, waveguides 706 and 708 have widths w₃ and w₂, respectively. On the left side of FIG. 7B, waveguides 706 and 708 have widths w₄ and w₁, respectively. The transition between the right and left sides is achieved through gradual waveguide width tapers. At all times, the waveguides are separated by a coupling gap g. Power incident on waveguide 706 moving in the left direction will gradually transfer waveguide 708, provided that the transition is slow compared to the coupling rate between the two waveguides. The adiabatic coupler is less sensitive to wavelength than the directional coupler.

The exemplary FM-OPO light sources of this work are based on ridge waveguide etched into x-cut thin film lithium niobate or other material with second-order nonlinearity. As an example, a thin film of lithium niobate is bonded to a substrate, such as but not limited to sapphire or silicon dioxide. In some embodiments, the waveguides can be locally suspended in air. The entire structure can be placed on a carrier wafer, for example, silicon or lithium niobate in the case of silicon dioxide substrate. The thin film can be periodically poled with period Λ by patterning a periodic metal electrode and applying high voltage pulses to the crystal, which inverts its domains as needed to provide quasi-phase matching.

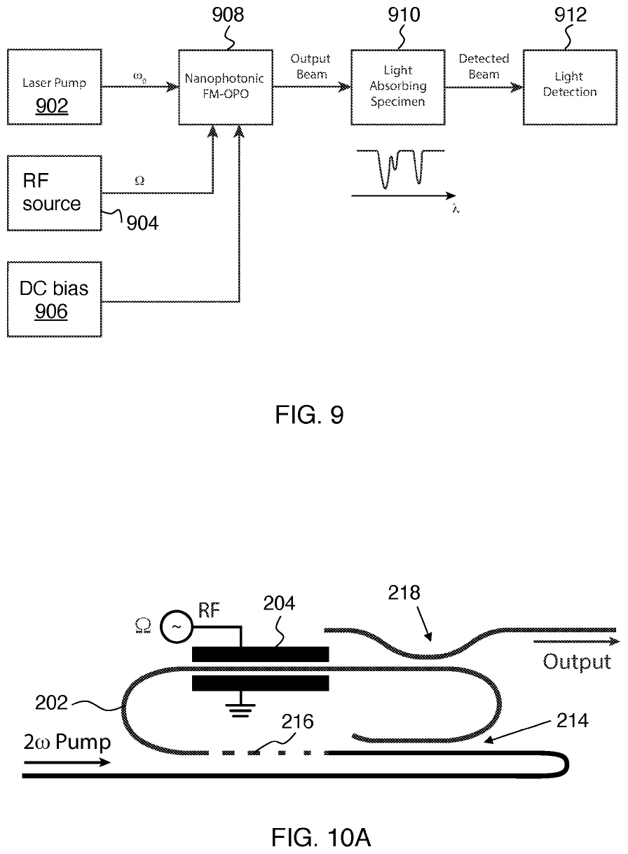

The FM-OPO can be coupled to the RF field through metal electrodes positioned next to the resonator waveguide. FIG. 8A depicts an example cross-section of a waveguide and electrodes. In the EO-coupling section, two metal electrodes (812a, b) are positioned on both sides of the ridge waveguide 804, directly on the thin film 806. In some embodiments, the waveguide is covered by a cladding layer 808. In that case, the electrodes connect to the top of the cladding 808 through etched vias 814, which allows for direct electrical connection. Here 802 is the substrate.

In some embodiments, the light sources are patterned in z-cut lithium niobate crystal and use the fundamental TM modes. In this case, the device's geometry differs from the x-cut version. FIG. 8B depicts a periodically poled lithium niobate z-cut waveguide, where the crystal z-axis directions are positioned vertically. Periodic poling of such a structure can be realized through a patterning metal electrode on top of the film and applying high voltage pulses vertically. The electrode geometry in the z-cut lithium niobate design requires an electric field pointing vertically. Two possible geometries are depicted in FIGS. 8B-C. In FIG. 8B, one electrode 810 is placed directly above the waveguide, and the others (812a, b) are placed to the sides. In FIG. 8C, electrode 810 is above the waveguide, and the other electrode 816 is buried under the substrate layer 802.

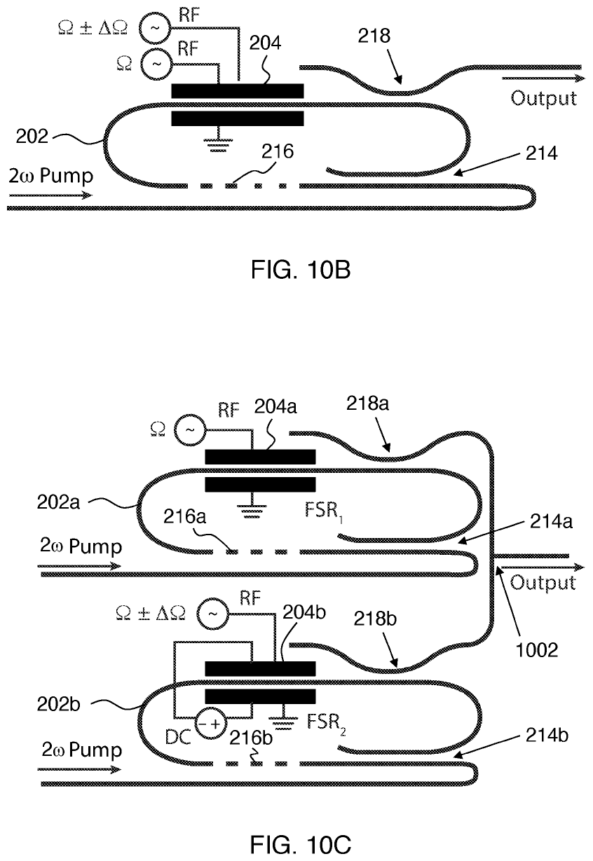

Embodiments of the invention are suitable for use as light sources for spectroscopy, as schematically shown in the block diagram of FIG. 9. Here a laser pump 902, RF input 904 and optional DC bias 906 are provided as inputs to the FM-OPO device 908. The resulting output beam (a frequency comb as described above) illuminates sample 910 and light from sample 910 is detected in detector 912.

In some embodiments, multiple RF frequencies are used to generate multiple combs within the same optical cavity or two FM-OPOs on the same chip (see description of dual-comb spectroscopy below). In some embodiments, a DC voltage source is included to bias the device with constant voltage. The output beam passes through a light-absorbing specimen, and its absorption spectrum is imprinted on the light intensity. In some embodiments, where two combs are generated, they can be separated before one of them passes through the specimen. Finally, the light is detected using methods such as, but not limited to, direct photodiode detection, fast photodiode detection with an RF spectrum analyzer, and wavelength-resolving spectrometers. The measured spectrum can be further used to identify and quantify measured specimens. In some embodiments, the light can generate an acoustic excitation when absorbed in the specimen, which can later be detected instead of light.

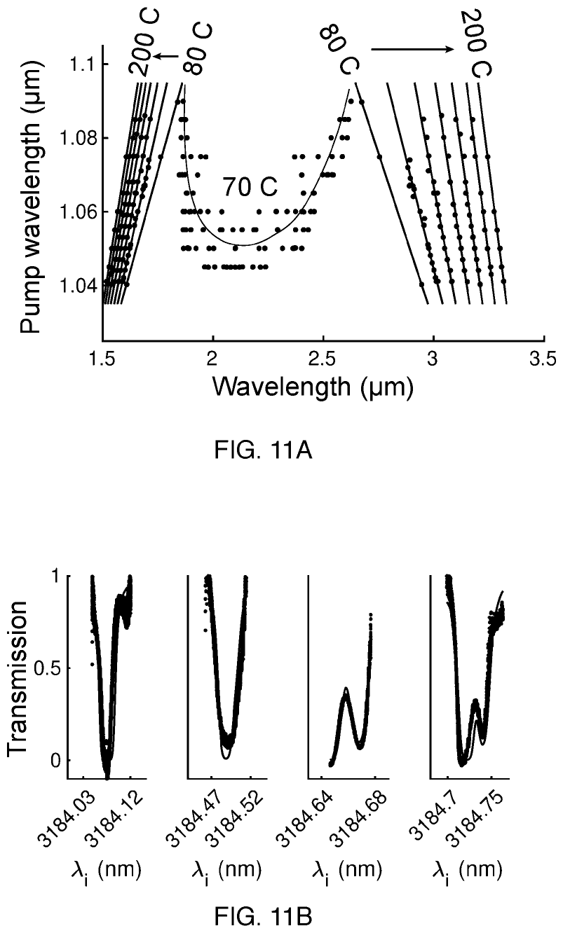

A single FM-OPO, as shown on FIG. 10A can be used for spectroscopy directly because the source emission exhibits frequency modulation and can hence directly scan over absorption line shapes. The configurations of FIGS. 10B-C show two ways to provide a source for dual-comb spectroscopy. On FIG. 10B, two RF tones are supplied to electrodes 204. The example of FIG. 10C has two FM-OPO devices disposed on the same chip, with their outputs combined in a combined 1002 (separate outputs is also an option). Here 202a, b, 204a, b, 214a, b, 216a, b, and 218a, b are the waveguide resonators, electrodes, pump couplers, periodically poled OPA sections, and output couplers, respectively, of the two FM-OPO devices. Two combs are generated by providing different RF tones to electrodes 204a and 204b. Further details on dual-comb spectroscopy follow. The two FM-OPO devices can be fabricated with different free spectral ranges (FSR1 and FSR2).

Alternatively, the difference can be controlled by tuning one or both cavities with mechanisms, such as but not limited to electro-optic and thermo-optic effects. In the latter case, the two FM-OPO devices can be fabricated with the same free spectral range.

Dual comb spectroscopy employs two optical frequency combs with slightly different free spectral ranges. First, a dual-comb is generated from Comb 1 with free spectral range Ω and Comb 2 with free spectral range Ω-ΔΩ. Next, either one or both combs are passed through an absorbing sample of interest. In cases where only one of the combs is passed through the sample, both combs are still provided to the detector. The light power transmission through the sample follows:

Pₒᵤₜ(λ)=Pᵢₙ(λ)e^{-α(λ)L}

where α(λ) is the absorption coefficient of the analyte sample, L is the path length of light through the analyte, and Pᵢₙ/Pₒᵤₜ are the input/output powers on the sample as a function of wavelength.

The relative powers of the comb lines located near absorption features will decrease. When the light from both Comb 1 and Comb 2 is combined and focused onto a photodetector, radiofrequency beat notes will be observed at frequencies fₙ=nΔΩ where n is an integer, and fₙ is the frequency of the n-th beat note. The radiofrequency spectrum contains spectrally-translated information from the optical absorption spectrum. Compared to other approaches, two FM-OPO combs can be generated with a very small difference in the free spectral range. The smaller spacing between comb lines enables us to fit many more lines within the same RF bandwidth, which means that lower bandwidth detectors with higher gain and better noise properties can be used.

In one realization, the dual-comb light source can be generated within a single FM-OPO device realization (FIG. 10B). Here, a superposition of two RF drives are applied to the cavity, at frequencies Ω and Ω−ΔΩ. In this realization, both combs are sent to the output waveguide. The light from the output waveguide can be collected either in a fiber or using a free space lens, then sent to an analyte and photodetector for dual-comb absorption spectroscopy.

In another realization, two distinct FM-OPO devices with different cavity round-trip lengths (and hence different free spectral ranges Ω, Ω−ΔΩ) can be fabricated on a single chip (FIG. 10C). RF signals can drive the two cavities at Ω and Ω−ΔΩ, producing a comb light source from each cavity. The two output combs can either be combined together in a single waveguide using a waveguide coupler or output separately. Again, either fibers or a free space system can collect the output light, which can be used for dual-comb spectroscopy. The difference in the free spectral range between the two cavities ΔΩ can be tuned using a DC voltage source applied to the FM-OPO electrode (FIG. 10C). It's also possible for ΔΩ to be zero.

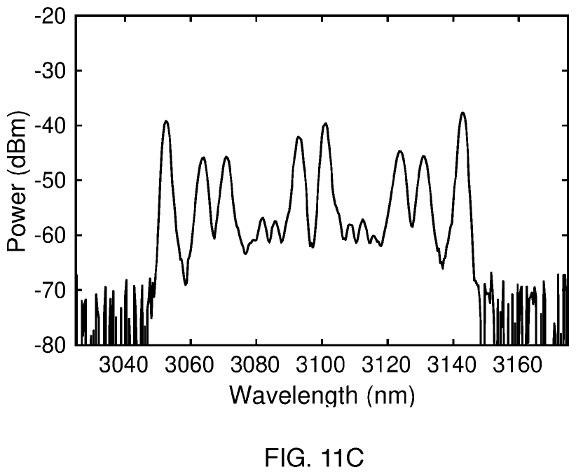

FIG. 11A shows a broad tuning properties of an unmodulated FM-OPO pumped at 1 um. Dispersion engineering, which is enabled by nanophotonic integration, allows for enhanced tuning abilities. Here, the pump wavelength and chip temperature are used in conjunction to tune the OPO emission over 1800 nm, including a significant portion in the MIR.

FIG. 11B shows that an unmodulated FM-OPO's MIR output can resolve narrow Doppler-broadened gas lines of methane by sweeping the pump laser. A modulated FM-OPO could resolve the same absorption features directly if the frequency-modulated emission sweeps directly over the absorption line shape.

FIG. 11C shows MIR frequency comb generation from a MIR FM-OPO pumped at 1550 nm.

We have successfully demonstrated the ability of this design to work highly non-degenerately in the mid-infrared, an important spectral region for spectroscopy. In this case, λ₀=1 μm, λ₁=1.5 μm, and λ₂=3 μm. The intra-resonator adiabatic coupler is designed to strongly transmit 1.5 μm light and only weakly transmit 1 μm light. Above an on-chip threshold power of roughly 50 mW at the pump wavelength of 1 μm, the device produces light at both λ₁ and λ₂. The emission is tunable by varying pump wavelength and chip temperature.

This OPO work can showcase the tunable spectroscopic capabilities of the FM-OPO design in the mid-infrared region. First, the device is coarsely tuned using pump wavelength and temperature so that the idler light at λ₂ overlaps with regions of methane absorption lines. Then, we scan the pump wavelength while the signal wavelength stays fixed on a cavity mode at λ₁. By energy conservation, the change in pump wavelength results in a change in idler wavelength, allowing us to scan over multiple absorption features in methane (FIG. 11B). Employing the FM-OPO design in the mid-infrared range will allow sampling wavelengths corresponding to all the accessible resonator modes simultaneously.

1. Apparatus comprising:
a substrate;
a first optical parametric oscillator (OPO) monolithically integrated on the substrate and including a first waveguide resonator;
wherein the first waveguide resonator includes a first material having a second order optical nonlinearity;
wherein the first waveguide resonator includes an intracavity phase modulator;
wherein providing first pump radiation to the first optical parametric oscillator and providing a first RF signal to the first intracavity phase modulator leads to emission of at least a first optical frequency comb.

2. The apparatus of claim 1, wherein the first optical frequency comb is not a pulse train in the time domain.

3. The apparatus of claim 1, wherein a frequency of the first RF signal is within 10% of a free spectral range of the first waveguide resonator.

4. The apparatus of claim 1, wherein the first waveguide resonator is resonant for both signal and idler radiation.

5. The apparatus of claim 1, wherein the first waveguide resonator is resonant for either signal radiation or idler radiation.

6. The apparatus of claim 1, wherein the first waveguide resonator is configured as photonic circuit Fabry-Perot resonator, a circular ring resonator or as a race track ring resonator.

7. The apparatus of claim 1, wherein the first material having a second order optical nonlinearity is periodically poled to provide phase matching.

8. The apparatus of claim 1, wherein the first waveguide resonator includes ridge waveguides fabricated in x-cut or z-cut lithium niobate.

9. The apparatus of claim 1, further comprising a frequency doubler monolithically integrated on the substrate, and wherein output radiation from the frequency doubler is the first pump radiation for the first optical parametric oscillator.

10. The apparatus of claim 1, further comprising:
a first pump coupler configured to couple the first pump radiation to the first waveguide resonator without coupling OPO signal or idler radiation out of the first waveguide resonator; and
a first output coupler configured to couple a predetermined fraction of OPO signal and/or idler radiation from the first waveguide resonator.

11. The apparatus of claim 1,
further comprising a detector selected from the group consisting of: photodetectors, photodetectors coupled to RF spectrum analyzers, wavelength-resolving spectrometers, and acoustic detectors; and
wherein the apparatus is configured to perform spectroscopic measurements on a sample using the detector and using the first frequency comb as an optical source.

12. The apparatus of claim 11, wherein the first RF signal includes a first RF tone and a second RF tone, wherein the first frequency comb is generated by the first RF tone, and wherein the second RF tone leads to emission of a second frequency comb superposed with the first frequency comb.

13. The apparatus of claim 11, wherein the substrate further comprises:
a second optical parametric oscillator (OPO) monolithically integrated on the substrate and including a second waveguide resonator;
wherein the second waveguide resonator includes a second material having a second order optical nonlinearity;
wherein the second waveguide resonator includes a second intracavity phase modulator;
wherein providing second pump radiation to the optical parametric oscillator and providing a second RF signal to the second intracavity phase modulator leads to emission of a second optical frequency comb.
